(19) United States
(12) Patent Application Publication
(10) Pub. No.: US 2008/0020909 A1
(43) Pub. Date: Jan. 24, 2008

(54) Safety Assistance Strap with Bar Attachments

(76) Inventors: Constance L. Blair, Florida City, FL (US); Joseph Bryan LaBoy, Florida City, FL (US)

Correspondence Address: CONSTANCE L. BLAIR, P.O. BOX 343137, FLORIDA CITY, FL, 33034, US

(21) Appl. No.: 11/456,980

(22) Filed: Jul. 12, 2006

(51) Int. Cl. A63B 1/00; A63B 31/00; A61H 3/00

(52) U.S. Cl. 482/69; 482/40; 482/43; 482/55

(57) ABSTRACT

The purpose of the safety and assistance strap is to securely suspend and also to provide quick height adjustment of dumbbells, barbells and exercise equipment to a specific height appropriate for the user prior to usage, beginning an exercise, and throughout the exercise acting as a safety device. As important is the finish and release of the equipment after the exercise whereby the safety assistance strap or SAS will prevent over extending. It is adjustable in heights in three large increments as well as numerous smaller increments. The present invention allows the user to quickly adjust the height, with one hand in large or small increments, without the need to remove the weight. It has a top end, which loops around horizontal supports and secures itself to a clasp upon the strap. The SAS has additional connection members at equal distances for quick height adjustment and a lower clasp at the end for the suspended exercise equipment. The SAS has a keyhole plate, which a chain passes through the keyhole for quick adjustments at smaller increments.

The SAS is made of material of nylon, cotton or pvc which is used extensively as cargo nets and safety tie down straps. The strength of these straps will far exceed a minimum safety requirement for the average weightlifter. The keyhole plate, of this apparatus, is used in heavy construction machinery to secure chains. Both the strap and the keyhole plate serve as a remarkable and efficient assistant and safety device for barbells, dumbbells and exercise equipment.

Continuation of provisional patent 60/595,504 filed on Jul. 11, 2005.

### FEDERALLY SPONSORED RESEARCH

Not Applicable

### BACKGROUND

### Field of Invention

A safety and assistance exercise apparatus to securely suspend and provide quick height adjustment of dumbbells, barbells and exercise equipment at an appropriate height for the user prior to usage, beginning an exercise, and throughout the exercise acting as a safety device. Equally important is the finish and release of the equipment after the exercise whereby the safety assistance strap or SAS will prevent over extending. It is quickly height adjusted in multiple large increments as well as numerous smaller increments.

### DESCRIPTION OF THE PRIOR ART

The prior art search revealed numerous configurations to support or suspend dumbbells, barbells and exercise equipment and aid in safety. The present invention incorporates the suspension of dumbbells, barbells and exercise equipment with a quick adjustment capability focusing on safety and convenience.

The purpose of the present safety and assistance strap invention is to securely suspend, provide quick height adjustment of dumbbells, barbells and exercise equipment to a specific height appropriate for the user prior to usage, beginning an exercise, and throughout the exercise acting as a safety device. The present invention is unique in the ability to perform exercises with a bench in any configuration, without a bench or while standing with quick adjustment and continual safety. Additionally, this present invention allows the user to quickly adjust the necessary height, with one hand in large or small increments, without the need to remove the weight. The materials used in the present invention are lightweight and of high tinsel strength, currently applied in cargo and strap down applications, and are the ideal material for convenience and portability. In the following references many other patents for weight support, suspension and safety will be examined and advantages and disadvantages discussed.

Height adjustment, raising and lowering of weight equipment in the patents found are typically limited to large frames with or without motorized components. Height adjustment in the patents found that claim to be portable are limited to the support of the specific frame that they are designed for, these apparatus must have the weight equipment removed prior to adjustment.

U.S. Pat. No. 4,216,959 to Niles, this apparatus does provide for adjustment as a safety device but it is not specifically intended to be used as a suspension device. Although it is small enough to be portable it is reliant on specific exercise support apparatus. The invention is specific to barbells (not dumbbells), particularly bench press and squat type exercises. To raise or lower this device, all weight must be removed or racked on the appropriate support apparatus.

The following patents are critiqued on the following issues: quick adjustment capability, continual safety throughout the exercise, and portability of the device. All of these patents are particular to dumbbells. In U.S. Pat. No. 6,436,016 to Valentino, adjustment is achieved through the support of the hook attachment, does not provide safety during the exercise, and is not portable because of the exercise frame that is required to provide suspension. The following patents are cradles, which support or suspend dumbbells off of an exercise support apparatus providing the adjustment capability, and having to remove the weight prior to adjustment. All of these dumbbell cradle or holders do not provide continual safety during the exercise. Portability of these devices are again contingent upon the specific equipment required to support or suspend them. U.S. Pat. Nos. 5,616,108, 5,772,561 and 5,924,964 all to Hayden, 6,715,728 to Nielsen, 6,149,556 to Jordan, 5,651,758 to Cervantes, 7,070,547 to Pater, 6,709,370 to Evans, 4,773,642 to Cruz, 4,666,150 to Segrist and 5,472,397 to Ammoscato.

The following patents are critiqued on the following issues: quick adjustment capability, continual safety throughout the exercise, and portability of the device. These patents consist of a generic frame to suspend barbells or dumbbells by use of counterweights and/or pulleys, which are nonmechanized. U.S. Pat. No. 4,973,050 to Santoro provides quick adjust through a pinhole feature on the frame of the upright support. It does provide for continual safety during the exercise movement. However, it is not portable due to the large frame that is required to utilize the two prior mentioned features. U.S. Pat. No. 4,998,723 to Santoro and U.S. Pat. No. 4,324,398 to Hole do provide adjustment on vertical supports of the apparatus frame as well as provide for continual safety during the exercise movement. However, the prior features are only available with the apparatus, which is not portable. U.S. Pat. No. 4,471,956 to Marlo and U.S. Pat. No. 4,709,922 to Slade, Jr. does not provide adjustment capability, does provide for safety during the movement of the exercise but is not portable and is unusable without being attached to a substantial mounting apparatus.

The following patents are critiqued on the following issues: quick adjustment capability, continual safety throughout the exercise, and portability of the device. The following patents are all motorized for safety and adjustment. The following patents have extensive framing as well as motors limiting their portability rendering them stationary except for U.S. Pat. No. 5,989,166 to Cappizio which is equipped on wheels providing mobility within a given area. U.S. Pat. No. 5,989,164 to Kullman, U.S. Pat. No. 5,823,921 to Dawson, U.S. Pat. No. 5,653,666 to Pantoleon, U.S. Pat. No. 5,310,394 to Kallios, U.S. Pat. No. 4,650,186 to McCreery, U.S. Pat. No. 6,669,607 to Slawinski, U.S. Pat. No. 6,926,649 to Slawinsky, 2004/0092369 to Slawinski, 2004/0192519 to Slawinski, U.S. Pat. No. 5,314,394 to Ronan and U.S. Pat. No. 5,108,354 to Becker. U.S. Pat. No. 7,001,314 to Hummer, Jr. displays a motorized dumbbell support with no safety during exercise.

### SUMMARY OF THE INVENTION

As can be seen by the foregoing disadvantages inherent in the known type of weight suspension now present in the prior art, the present invention provides an improved suspension system with quick adjustment and overcomes the above mentioned disadvantages of the prior art.

The purpose of the safety and assistance exercise apparatus is to securely suspend and also to provide quick height adjustment, of dumbbells, barbells and exercise equipment at a specific height appropriate for the user prior to usage, beginning an exercise, and throughout the exercise acting as a safety device. The safety and assistance strap is a new and improved form of suspension and safety and employs many novel features such as quick adjustment, which result in a device, which is not anticipated or rendered obvious.

It is a first and primary object of the present invention to provide a safety and assistance strap with quick adjustment; the raising or lowering of dumbbell, barbell or exercise equipment entirely while weight of equipment is supported on the safety assistance strap. The quick adjustment is achieved using a clasp on a single or multiple connection member, for substantial height adjustment of the exercise equipment. Additional quick adjustment is made with the raising or lowering of adjustment chain through the keyhole for small height adjustment of the exercise equipment. Various exercises begin at different heights employing the advantage of quick, small and large incremental height adjustment.

A further object of the present invention is to provide a safety and assistance strap, which is quickly adjusted to any height to accommodate a user in a standing, sitting or lying down position eliminating any stress setting up prior to exercise.

A further object of the present invention is to provide a safety and assistance strap, which is easily and quickly moved to any location with any substantial overhead horizontal support. It can be seen that the need for space consuming stationary machines or similar devices could be eliminated.

A further object of the present invention is to provide a safety and assistance strap, which eliminates the need for gripping the weight before commencing exercise eliminating stress of users hands and arms.

A further object of the present invention is to provide a safety and assistance strap, utilizing the suspension of the dumbbell, barbell or exercise equipment providing safety throughout the exercise eliminating the need for a spotter and eliminating fatigue or strength concerns.

A further object of the present invention is to provide a safety and assistance strap, eliminating lifting equipment off floor causing possible injury.

A further object of the present invention is to provide a safety and assistance strap, which can be permanent eliminating the need to retrieve and then to return weight to equipment rack.

Another object of the present invention is to provide a safety and assistance strap, eliminating the need for user to return the exercise equipment to the floor upon completion of exercise with an already fatigued muscle causing possible over extension and injury.

Another object of the present invention is to provide a safety and assistance strap, which provides the user with a stationary spot curtailing the need to relocate to an alternate area for different exercises.

In another embodiment the safety assistance strap will suspend various objects while being simple and quick to adjust the height of the object, in large increments as well as smaller increments, and having the convenience of being portable. Objects of considerable weight can be hooked to the safety assistance strap near to the ground and then lifted and secured in small increments thereby not straining the user in lifting the object off the floor.

### DRAWINGS

### Drawing Figures

In the drawings, closely related figures have the same number but different alphabetic suffixes.

FIG. 1 is a front overall view of the safety assistance strap.

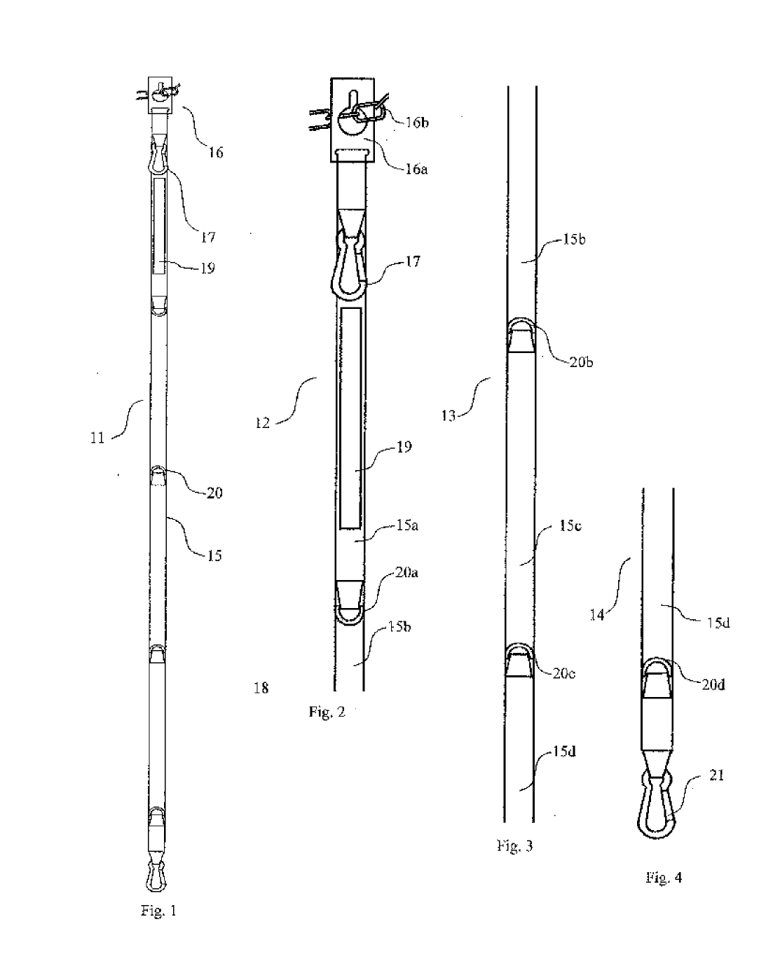

FIG. 2 is a front sectional view of the loop end of the safety assistance strap.

FIG. 3 is a front sectional view of the adjustment section of the safety assistance strap.

FIG. 4 is a front sectional view of the attachment end of the safety assistance strap.

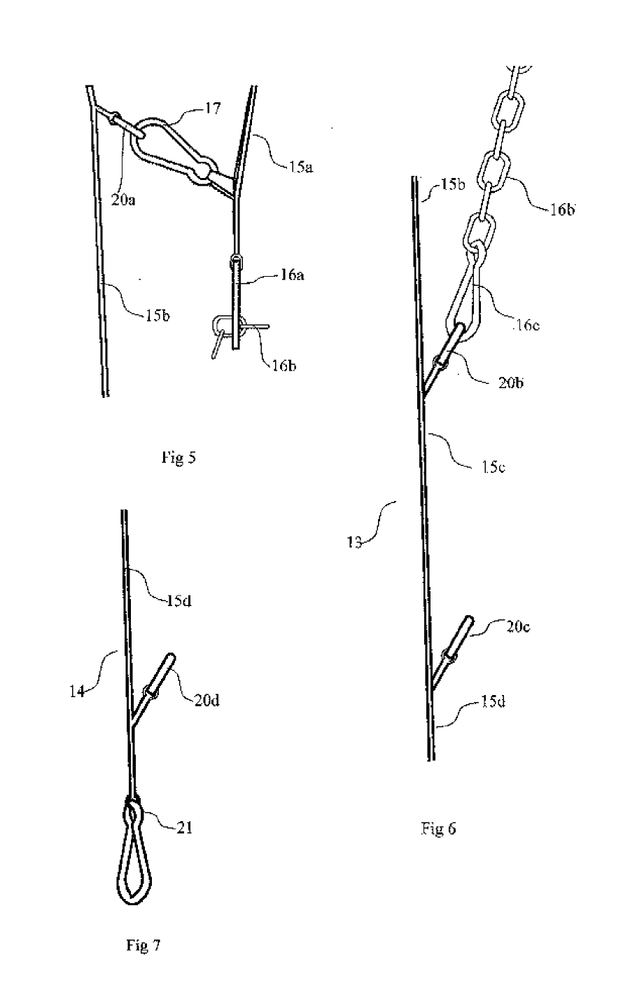

FIG. 5 is a side view of closed loop section.

FIG. 6 is a side view of adjustment section

FIG. 7 is a side view of attachment end section

FIG. 8 is a view of keyhole plate and chain mechanism attached to connection member

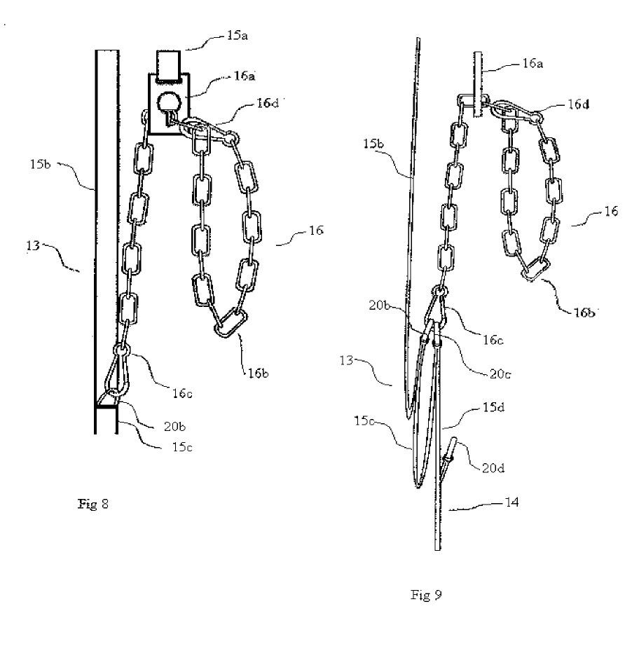

FIG. 9 is a side view of keyhole plate and chain mechanism attached to multiple adjustment connection members

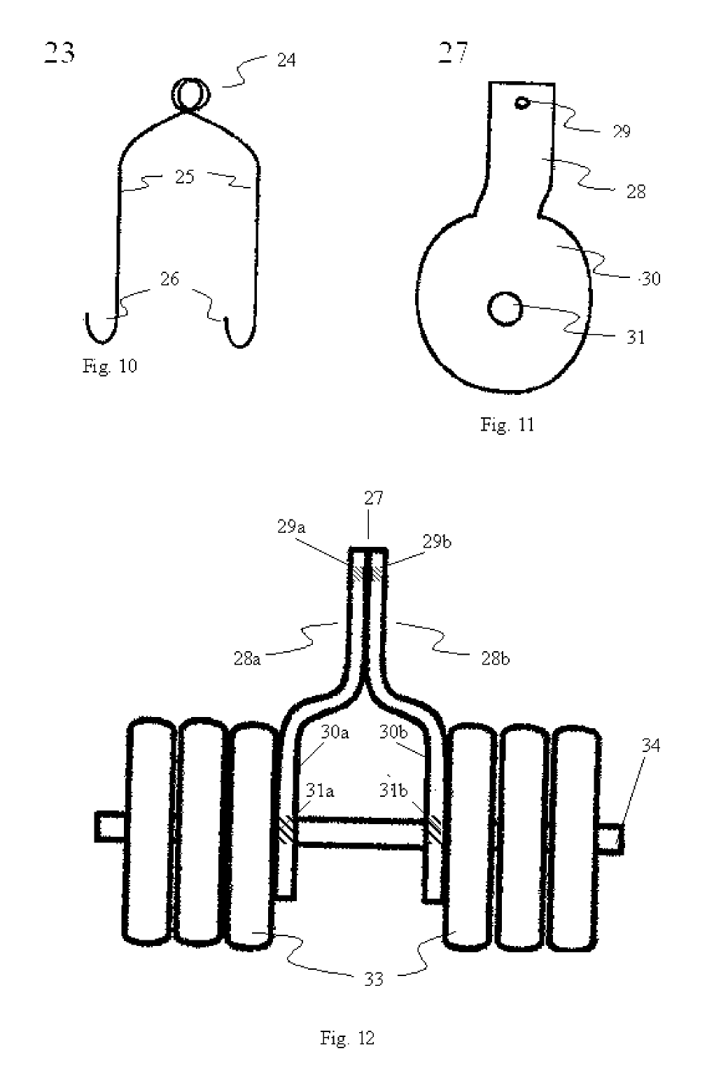

FIG. 10 is a semi-front overall view of bar attachment cradle

FIG. 11 is a front view of bar plate attachment holder

FIG. 12 is a front overall view of a pair of bar plate attachment holder with dumbbell attached

### DESCRIPTION

### Detailed Description

### FIG. 1

FIG. 1 is a front view of a safety assistance strap 11 constructed in accordance with the invention.

### FIG. 2

FIG. 2 is the loop end section 12 of a safety assistance strap 11. The safety assistance strap 11 is constructed of strap type material 15. The material may be cotton, nylon or pvc. The keyhole plate and chain mechanism 16 is attached to the end of the loop end section 12. The loop end clasp 17 is on the same end with the keyhole plate and chain mechanism 16 of the loop end section 12. The loop end clasp 17 connects and is secured to loop end connection member 20a closing the loop end section 12 and providing loop for suspending from an overhead horizontal support member. The inner surface of the loop end section 12 has a non-slip material or surface 19.

### FIG. 3

FIG. 3 is the adjustment middle section 13 of the safety assistance strap 11. The strap 15 continues the length of the adjustment middle section 13. The adjustment middle section 13 shows two equally distanced adjustment connection members 20b and 20c along the length of the strap 15.

### FIG. 4

FIG. 4 is the attachment end section 14 of the safety assistance strap 11. The attachment end section 14 is a continuing length of the strap 15 having a 3^{rd} adjustment connection member 20d near the end and an attachment end clasp 21 on the end of the strap 15.

### FIG. 5

FIG. 5 is the loop end section 12 of the safety assistance strap 11. Side view of the strap 15 with partial view of the loop end strap 15a and partial view of the 1^{st} adjustment section strap 15b is shown. FIG. 5 shows how the keyhole plate and chain mechanism 16 hangs when the loop end clasp 17 is attached to loop end connection member 20a closing the loop end. FIG. 5 also shows keyhole plate and chain mechanism 16 the side view of the keyhole plate 16a with partial view of adjustment chain 16b.

### FIG. 6

FIG. 6 is the adjustment end section 13 of the safety assistance strap 11. Side view of the strap 15 with partial view of the 1^{st}, 2^{rd}, and 3^{rd} adjustment section straps 15b, 15c and 15d are shown. FIG. 6 shows a continuing length of the strap 15 and adjustment chain 16b and clasp attachment 16c attached to 1^{st} adjustment connection member 20b of the adjustment middle section 13 of the safety assistance strap 11. FIG. 6 also shows portions of the strap 15, 1^{st}, 2^{rd}, and 3^{rd} adjustment section strap 15b, 15c and 15d which are equal in lengths between loop end connection member 20a (not shown) and 1^{st} and 2^{nd} adjustment connection members 20b and 20c. FIG. 6 shows partial view of adjustment chain 16b which is equal but not less than the length from loop end connection member 20a, and 1^{st} and 2^{nd} adjustment connection members 20b and 20c.

### FIG. 7

FIG. 7 is the attachment end section 14 of the safety assistance strap 11. FIG. 7 shows a side view of the continuing length of the strap 15. FIG. 7 shows 3^{rd} adjustment section strap 15d, a 3^{rd} adjustment connection member 20d of the attachment end section 14 and the attachment end clasp 21.

### FIG. 8

FIG. 8 is the loop end strap 15a with the adjustment chain 16b set with clasp attachment 16c attached to 1^{st} adjustment connection member 20b between 1^{st} and 2^{nd} adjustment section strap 15b and 15c. Also shows adjustment chain 16b chain security clasp 16d attached to chain link closest to keyhole plate 16a for security.

### FIG. 9

FIG. 9 is the keyhole plate and chain mechanism 16 attached to adjustment middle section 13. Keyhole plate 16a has adjustment chain 16b through keyhole with clasp attachment 16c attached to 1^{st} and 2^{nd} adjustment connection member 20b and 20c, also adjustment chain 16b has clasp security 16d attached to first link closest to keyhole plate 16a on clasp security 16d side. FIG. 9 shows how adjustment middle section 13 is attached to clasp attachment 16c, by 1^{st}, and 2^{nd} adjustment connection members 20b and 20c.

### FIG. 10

FIG. 10 is the bar attachment cradle 23. The cradle attachment opening 24 is comprised of a rounded steel rod bent in the middle in a closed loop. Cradle arms 25 are the continuation of the rounded steel rod at opposite ends of the loop bent parallel to point in a perpendicular direction to the cradle attachment opening 24. The cradle bar ends 26 are the continuation of the rounded steel rod of the cradle arms 25 bent parallel and perpendicular in a semicircle fashion which creates an opening to cradle the bar.

### FIG. 11

FIG. 11 is the bar plate attachment holder 27. The bar plate attachment holder 27 is comprised of a rigid, flat metal material with a narrow rectangular arm 28. Near the end of the arm 28 is the bar plate attachment hole 29. The bar plate attachment holder 27 also has a circular end, the plate end 30 which is a continuation of the arm 28. The plate end 30 has a bar opening 31 in the center of it.

### FIG. 12

FIG. 12 shows a pair of bar plate attachment holder 27. The arm, left 28a is mirrored the arm, right 28b. The plate end, left 30a and plate end, right 30b are shown between the weights 33 and with the bar 34 through the weights and the pair of bar plate attachment holder 27.

### OPERATION

### FIG. 1

FIG. 1 is an overall view of the safety assistance strap 11. The safety assistance strap 11 is used singularly for a dumbbell or multiply for a barbell suspending dumbbells and barbells. The safety assistance strap 11 also suspends various exercise equipment. Operation is discussed in FIG. 5-FIG. 9. These figures show the invention in operation.

### FIG. 5

The strap 15 loop end section 15a is looped over an overhead horizontal support member and the loop end clasp 17 is attached to loop end connection member 20a closing the loop and suspending keyhole plate 16 and 1^{st} adjustment strap section 15b vertically to suspend and adjust dumbbell, barbell or exercise equipment. The keyhole plate 16a is attached at the end of the loop end strap 15a. The keyhole plate 16a also has an adjustment chain 16b fed through the keyhole plate 16a for small incremental secure adjustment.

### FIG. 6

FIG. 6 is the clasp attachment 16c from the adjustment chain 16b attached to 1^{st} adjustment connection member 20b of the adjustment middle section 13 so that the strap adjustment section 13 is shortened by adjusting at smaller increments adjustment chain 16b. FIG. 6 also has additional 2^{nd} adjustment connection member 20c as well as 1^{st}, 2^{nd} and 3^{rd} adjustment section strap 15b, 15c and 15d which are all used to shorten or lengthen adjustment middle section 13 which raises or lowers barbell, dumbbell or exercise equipment.

### FIG. 7

FIG. 7 is the attachment end clasp 21 where a cradle attachment opening 24 of the bar attachment cradle 23 (shown in FIG. 10) or the bar plate attachment hole 29 of the bar plate attachment holder 27 (shown in FIG. 12) is clasped for suspension at the very end of the attachment end section 14, with a 3^{rd} adjustment connection member 20d and the 3^{rd} adjustment section strap 15d used to lengthen or shorten end section strap 14 raising or lowering the barbell, dumbbell or exercise equipment.

### FIG. 8

FIG. 8 is the keyhole plate and chain adjustment mechanism 16 attached to adjustment middle section 13. The keyhole plate 16a of the keyhole plate and chain adjustment mechanism 16 is attached to the loop end strap 15a suspending it over a horizontal support member. The keyhole plate 16a has an adjustment chain 16b fed through the keyhole of the keyhole plate 16a. The adjustment chain 16b has two clasps; clasp attachment 16c and chain security clasp 16d on each end. The adjustment chain 16b is adjusted or pulled through the hole of the keyhole plate 16a shortening or lengthening clasp 16c. The adjustment chain 16b shortens or lengthens the adjustment middle section 13 in small increments by links when clasp 16c is attached to 1^{st} adjustment connection member 20b specifically 1^{st} adjustment section strap 15b. Chain security clasp 16d is attached to or clasped to adjustment chain 16b link closest to the keyhole plate 16a on the chain security clasp 16d side. Keyhole plate and adjustment chain mechanism 16 securely adjusts suspended barbell, dumbbell or exercise equipment in smaller increments.

### FIG. 9

FIG. 9 is the keyhole plate and chain adjustment mechanism 16 attached to adjustment middle section 13, explained in detail below, shortening the attachment end section 14 raising the dumbbell, barbell or exercise equipment. The keyhole plate 16 has the adjustment chain 16b fed through a side view of the keyhole plate 16a adjusted with the clasp attachment 16c attached to 1^{st} and 2^{rd} adjustment connection members 20b and 20c. Also shown are chain security clasp 16d attached to the adjustment chain 16b link closest to the keyhole plate 16a on the chain security clasp 16d side. The adjustment middle section 13 is adjusted by 1^{st} adjustment connection member 20b and 2^{nd} adjustment connection member 20c when they are clasped to clasp attachment 16c. Adjustment middle section 13 is shortened in larger increments when 1^{st}, 2^{nd} and 3^{rd} adjustment connection members are attached to clasp attachment 16c shortening the height of a barbell or dumbbell. The adjustment middle section 13 is divided into three adjustment sections, 1^{st}, 2^{rd} and 3^{rd} adjustment strap 15b, 15c and 15d which are adjusted individually or multiply when clasped to adjustment clasp 16c which raised and lowers at larger increments than the adjustment chain 16b raising and lowering the attachment end section 14.

### FIG. 10

The cradle attachment opening 24 of the bar attachment cradle 23 is clasped to the attachment end clasp 21 of the safety assistance strap 11 (not shown). The bar 34 is placed evenly in the cradle bar ends 26.

### FIG. 11

Operation is discussed in FIG. 12. This figure shows the invention in operation.

### FIG. 12

The bar plate attachment holders 27, are a mirrored pair; arm, left 28a and arm, right 28b which touch each other to bring into alignment the bar plate attachment hole, left 29a and bar plate attachment hole, right 29b to receive the attachment end clasp 21 of the safety assistance strap 11 (not shown). With the mirrored and touching arm, left 28a and arm, right 28b the plate end, left 30a and plate end, right 30b are spaced apart from each other. A bar 34 is inserted through the aligned bar opening, left 31a and bar opening, right 31b of the plate end, left 30a and plate end, right 30b. The weights 33 are also attached on the bar 34

What is claimed is:

1. A safety strap for suspension of barbell, dumbbell and exercise equipment to provide quick adjustment, security and portability for user comprising:
a rigid plate, an adjustment chain
said rigid plate having a predetermined cutout with an elongated slot wherein
said cutout provides passage for said adjustment chain
said slot providing placement of securing link of adjustment chain
wherein said adjustment chain is of a predetermined length
wherein before link of securing link is perpendicular stopping the adjustment chain through the elongated slot
wherein after link of securing link is perpendicular stopping the adjustment chain through said elongated slot
wherein said adjustment chain having a safety clasp end
means for affixing said safety clasp to an adjustment chain and providing secondary mechanism to prohibit accidental slippage of the aft link
an elongated material attached to said rigid plate
wherein said material is of cotton, nylon or pvc
wherein said material having a plurality of thickness and width
wherein said material having a plurality of symbols on its surface
the elongated material having a plurality of predetermined rigid connecting members appropriately affixed
said elongated material having said plurality of predetermined rigid connecting members appropriately spaced
said adjustment chain having an attachment clasp end
means for attaching a connecting member by attachment clasp and adjusting height in substantial increments wherein clasping of said connection member singly
means for attaching plurality of connecting members by attachment clasp and adjusting height in substantial increments wherein clasping of said connection members plurally
means for attaching plurality of connecting members by attachment clasp and adjusting height in substantial increments wherein clasping of connection members in combination

2. The safety strap of claim 1 wherein the elongated material having a securing clasp appropriately affixed
means for forming loop and suspending from substantial horizontal support
said securing clasp attached singly to primary connecting member
wherein said loop having an inner surface of nonslip material
wherein said nonslip material being a rubber
whereby the user quickly adjusts the height in large or small increments of the dumbbell, barbell or exercise equipment with safety and assistance prior to usage, beginning an exercise and throughout the exercise.
